(19) United States
(12) Patent Application Publication
(10) Pub. No.: US 2019/0007302 A1
(43) Pub. Date: Jan. 3, 2019

(54) Mechanism for Dual Active Detection Link Monitoring in Virtual Switching System with Hardware Accelerated Fast Hello

(71) Applicant: Cisco Technology, Inc., San Jose, CA (US)

(72) Inventors: Linda T. Cheng, San Jose, CA (US); Manpreet Singh Sandhu, San Jose, CA (US); Subrat Mohanty, Los Gatos, CA (US); Ali Ahmad Tareen, Milpitas, CA (US); Ganesh Srinivasa Bhat, Union City, CA (US)

(73) Assignee: Cisco Technology, Inc., San Jose, CA (US)

(21) Appl. No.: 15/637,034

(22) Filed: Jun. 29, 2017

(51) Int. Cl. H04L 12/703; H04L 12/46; H04L 12/26; H04L 12/28; G06F 13/24

(52) U.S. Cl. CPC H04L 45/28; H04L 12/4645; H04L 45/22; H04L 12/28; G06F 13/24; H04L 43/0811

(57) ABSTRACT

Methods and systems are disclosed. Methods and systems include enabling MacSec in a frontside stacking environment. The method includes: creating a prepended frame descriptor to a packet; and placing SecTag control information in the prepended frame descriptor. Further methods and systems include enabling Pause and OAM in a frontside stacking environment. The method includes: identifying a size of a packet; and if the size of a packet is less than or equal to 64 bytes, examining the packet for a Pause or an OAM frame format.

### TECHNICAL FIELD

This disclosure relates in general to methods and systems for optimizing use of active and standby nodes in a network, and more particularly, to recovery of switches when an active node goes down and a standby node is activated.

### BACKGROUND

Switches comprise backside ports and frontside ports. Backside ports are used to, for example, connect one switch to another switch to form a switch stack, or a stacked switch. Backside ports typically have a maximum link distance of five meters or less, but communicate at a very high speed. Frontside ports are ports used to typically attach devices to the switch. The advantage of frontside Ethernet ports is that they can connect devices over long distances, but at a speed slower than the connection speeds of backside ports.

When using frontside stacking however, certain features need special consideration to be fully supported. Those features include MacSec, Pause, OAM, and SPAN. Full utilization of these features would be desirable in a frontside stacking network.

In addition, these networks often have two switching units connected over an Ethernet link called Stackwise Virtual Link (“SVL”). In past systems, one of these switching units, or nodes, would act as the active unit and one would act as a standby unit. When the active unit is detected as being down, the standby unit becomes the active unit. However, there is no mechanism to recover the switches back into an active switch with a standby switch once the formerly active switch is healthy.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flowchart for enabling SPAN in frontside stacking consistent with embodiments of the present disclosure.

FIG. 2 is an exemplary network with active and standby switches consistent with embodiments of the present disclosure.

FIG. 3 illustrates a flowchart of an active/standby methodology consistent with embodiments of the present disclosure.

### DESCRIPTION OF EXAMPLE EMBODIMENTS

### Overview

Methods and systems for enabling MacSec in a frontside stacking environment are provided. The method includes: creating a prepended frame descriptor to a packet; and placing SecTag control information in the prepended frame descriptor.

Methods and systems for enabling Pause and OAM in a frontside stacking environment are provided. The method includes: identifying a size of a packet; and if the size of a packet is less than or equal to 64 bytes, examining the packet for a Pause or an OAM frame format.

Also disclosed is a method of enabling SPAN in a frontside stacking network. The method includes: receiving an incoming spanSessionMap from a frontside stack frame descriptor; generating a second spanSessionMap which may include the frontside stack port; logically OR'ing the incoming spanSessionMap with the second spanSessionMap to form a resultant spanSessionMap; and placing the resultant spanSessionMap in the frontside stack frame descriptor.

Further disclosures include a method of operating a first switch and a second switch as respective active and standby switches connected by dual active detection (“DAD”) links. The method includes: when the second switch becomes active, checking if a port on the second switch associated with the DAD Link is up; when the DAD link is up, triggering a reload message over the DAD link from the second switch to the first switch and setting the second switch as the active switch; when the first switch receives the reload message over the DAD link, reloading the first switch; and when the first switch comes up as a standby switch and when a stack is not formed, sending from the first switch to the second switch a reload message over the DAD link.

A final disclosure is a method of sending hello messages from a first switch to a second switch over a dual active detection (“DAD”) link. The method includes sending an Ethernet OAM based hello over the DAD link from the first switch to the second switch.

### Example Embodiments

In order to provide a more full set of features when using frontside stacking, new systems are provided to provide a feature set comparable to what is achievable across a backside stack. While most features have been available, three in particular take special consideration because they involve L1 and L2 layers, or because the frontside stack operates as a backplane, rather than as a networking port. These features include the following. MacSec (802.1ae) has not worked with frontside stacking because frontside stacking requires prepending a frontside stack frame descriptor to the frame. This prepending frame descriptor prevents the MacSec engine from finding the SecTag. Pause (802.3x, 802.3bd) and OAM Connectivity Check (802.1ag) have not worked because the prepended frontside stack frame descriptor prevents network interface logic from identifying these frames. Finally, selection of a frontside stack port as a Switch Port Analyzer (“SPAN”) source when performing port mirroring or port monitoring has not functioned.

In order to permit MacSec functioning, an embodiment of the present disclosure puts the MacSec header attached to the prepended frame descriptor with a MacSec ethertype. Specifically, in a frame type 88E5, the SecTag with be the next six or fourteen bytes. The SecTag informs the recipient of whether the packet is protected with authorization and/or encryption.

Pause and OAM features are different from other packets sent by a node, or switch, because they are generated and terminated at the network interface level. Pause frames inform the other switch at the DLL level to pause sending packets because the buffer is full, for example. OAM is like a hello feature in that it is a keep alive message. In an embodiment consistent with the present disclosure, Pause and OAM are recognized by the packet size. OAM frames used in frontside stack ports use a MAID field that is reduced in size from 48 bytes to 16 bytes. Thus, both Pause and OAM frames have a packet length of 64 bytes when traversing the frontside stack. Because all other packets traversing the frontside stack are the minimum size of an Ethernet frame plus the size of the frame descriptor (32 or 64 bytes), any frame of 64 byte size received by the network interface is a Pause or OAM frame. Thus, it can be examined by a network interface logic because it starts with an Ethernet header, rather than a frame descriptor. In another embodiment, the OAM and PAUSE frames can be identified by parsing past the frame descriptor to look for the identifying frame formats in the succeeding bytes.

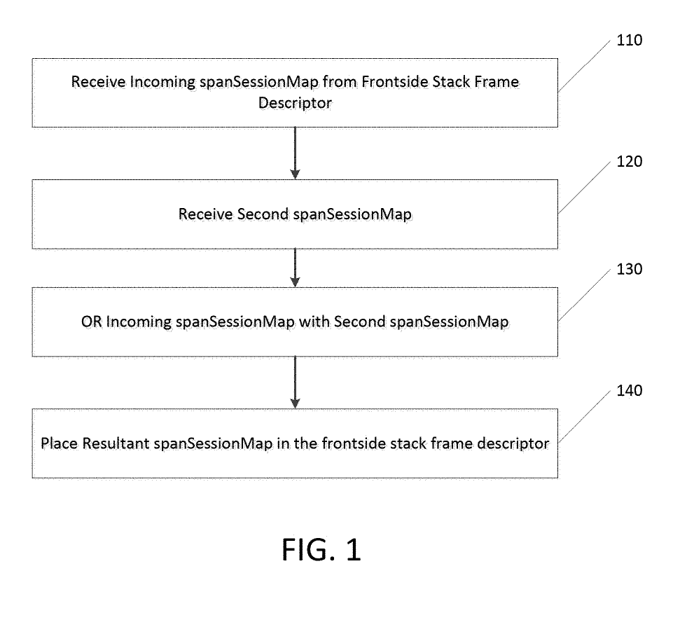

FIG. 1 is a flowchart for enabling SPAN in frontside stacking consistent with embodiments of the present disclosure. Embodiments consistent with the present disclosure also provide for SPAN. SPAN allows users to select a port or VLAN and get a copy of the traffic to appear on a debug port. SPAN provides for local SPAN to get the copy on the same switch; remote SPAN which adds a VLAN tag to get the copy on a different switch; and extended remote SPAN to add L2 and L3 headers to send the traffic to a different switch anywhere in the world. To provide this feature, an incoming spanSessionMap from an incoming frontside stack frame descriptor is preserved (stage 110). The spanSession Map is then OR'ed with a second spanSessionMap which is set if the frontside stack port is enabled as a SPAN source (stages 120 and 130). This logical function may be performed on both ingress and egress in order to support both ingress and egress SPAN After this OR'ing function, the resultant merged spanSessionMap is written back into the frontside stack frame descriptor (stage 140).

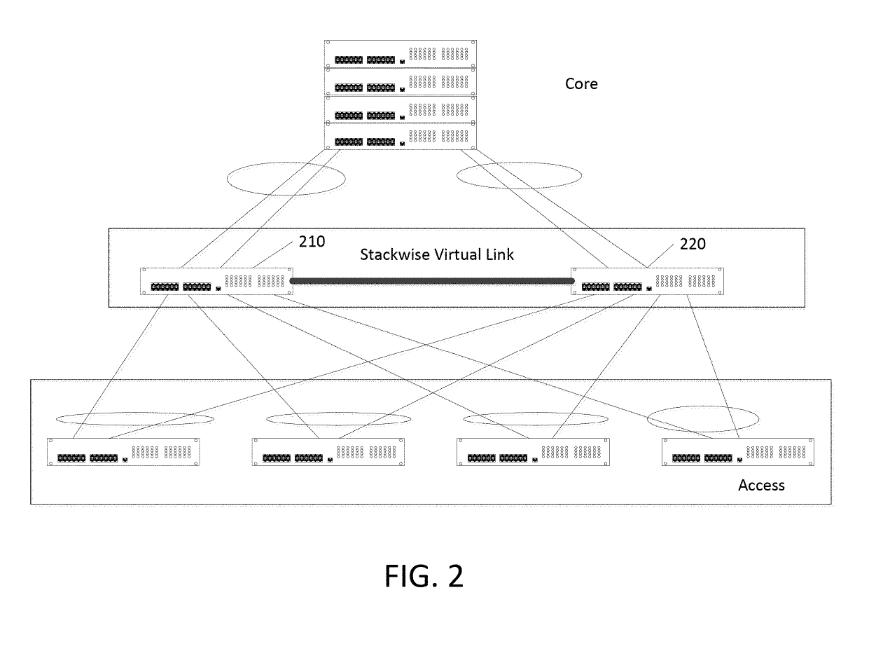

FIG. 2 is an exemplary network with active and standby switches consistent with embodiments of the present disclosure. FIG. 2 will be useful in discussing the remaining embodiments of the present disclosure. FIG. 2 illustrates a core node communicating with a pair of switches 210 and 220 that in turn communicate with nodes at an access level. The exact network configuration may be any arbitrary configuration with two nodes, such as switches 210 and 220, acting as a respective active node and standby node.

Switches 210 and 220 are connected together by Ethernet links known as SVL or Stackwise Virtual Link. In normal operation, Switch 210 acts as the active switch governing the control and management plane. Switch 220 acts as a hot standby switch ready to take over in case active Switch 210 were to fail. There may be several reasons why communications may be lost between active Switch 210 and standby Switch 220: the SVL may fail due to a fiber cut; there may be physical layer issues in one or both of the switches; there may be control plane issues in one or both of the switches; or there may be misconfiguration of the switches.

If keep alive communication between the switches is lost, the standby Switch 220 believes that the active Switch 210 is unavailable and takes over the system as the active switch. If this results in both switches being active, then there are two switches in the network with the same IP address forwarding packets. This should be prevented.

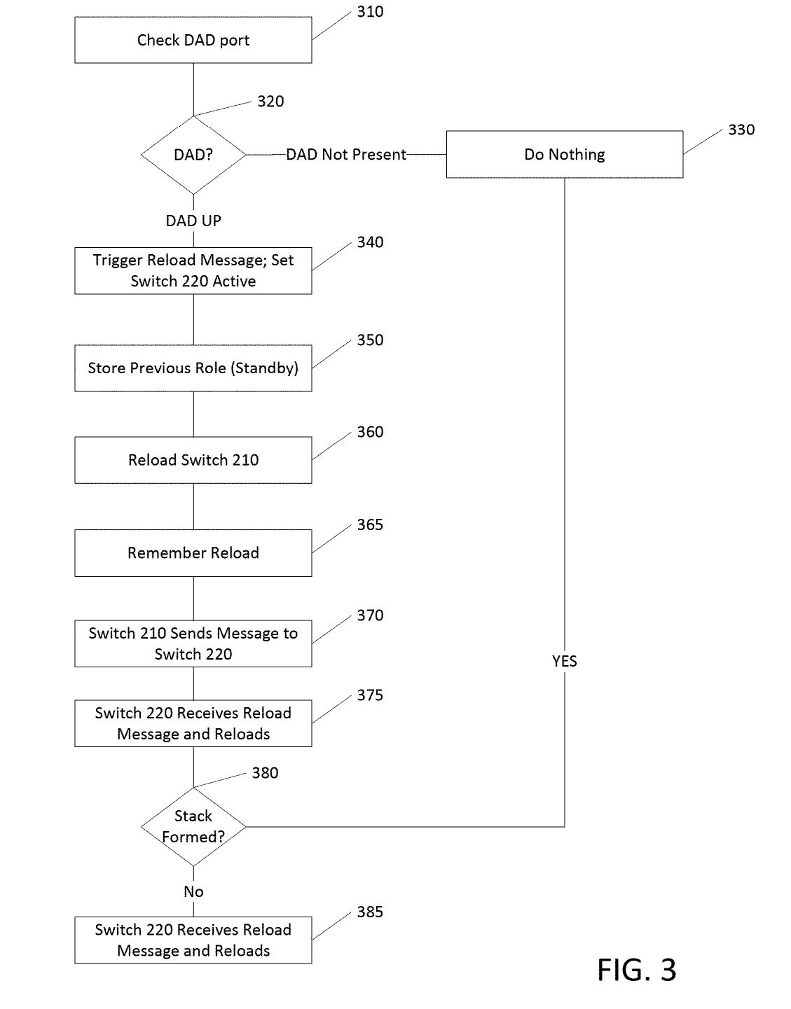

FIG. 3 illustrates a flowchart of an active/standby methodology consistent with embodiments of the present disclosure. Embodiments of the present invention use one or more links as “dual active detection” or “DAD” links to connect the peer switches together. When standby Switch 220 becomes active, it checks if the DAD port is configured and is up and running (stage 310). If it is not present, or it is up and running (stage 320), nothing is done (stage 330). If the DAD port is up, it triggers a reload message over the port and proceeds to set Switch 220 as the active switch (stage 340). Switch 220 also stores its previous role (as a standby switch) in a common variable (stage 350).

Switch 210 upon receiving a message from Switch 220 that Switch 220 has become the active switch reloads itself (stage 360) and remembers that it reloaded because of the message over DAD (stage 365). When Switch 210 comes up again as a standby switch, if the stack is not formed, Switch 210 sends a reload message over the DAD port (if it is up), that it reloaded because of DAD (stage 370). This enables both switches to have an opportunity to correct themselves.

Once the roles of Switch 210 and Switch 220 have been reversed, Switch 220 receives the DAD reload message and reloads itself (remembering that it reloaded because of DAD (stage 375). When Switch 220 comes up, if a stack is not formed (i.e., it comes up as active and checks if the previous state was standby) (stage 380), it shuts down all the network interface ports (stage 385). This helps to ensure that only the active switch does packet forwarding.

In addition to using the DAD link to prevent having two switches active at the same time, the DAD link has hello messages that propagate across the nodes on the order of 2-20 packets per second. This adds significant overhead for the CPU and detection may be delayed. The present disclosure provides for an Ethernet OAM based hello over the DAD link for hardware level detection of link failure. Ethernet OAM based communication goes from chip to chip between the nodes.

In a two node redundant system, nodes are connected over a dedicated link (a DAD link) in case the internode communication is lost. For health checks of the DAD link, both nodes will send fast hello messages generated by the CPU—adding to CPU overhead and slowing down other processes and making fault detection on the order of hundreds of milliseconds. In other words, quite slow fault detection. By using Ethernet OAM based fast hellos, the disclosure may provide for mechanisms on the order of milliseconds. without reducing the bandwidth of the link while also providing reduced CPU load. Upon detection of a fault using Ethernet OAM based fast hellos, the ASIC in the switch may generate an interrupt or, in an alternative embodiment, the CPU may poll the ASIC to get the failure notification. Upon detection of not receiving a hello message, a standby switch may become an active switch. Or, for an active switch, upon not receiving a hello message, triggering an alert that the standby switch is offline.

Any process, descriptions or blocks in flow charts or flow diagrams should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved. In some embodiments, steps of processes identified in FIGS. 1 and 3 using separate boxes can be combined. Further, the various steps in the flow diagrams illustrated in conjunction with the present disclosure are not limited to the architectures described above in association with the description for the flow diagram (as implemented in or by a particular module or logic) nor are the steps limited to the example embodiments described in the specification and associated with the figures of the present disclosure. In some embodiments, one or more steps may be added to the methods described in FIGS. 1 and 3 either in the beginning, end, and/or as intervening steps, and that in some embodiments, fewer steps may be implemented.

It should be emphasized that the above-described embodiments of the present disclosure are merely possible examples of implementations, merely set forth for a clear understanding of the principles of the switching systems and methods. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

We claim:

1. A method of enabling MacSec in a frontside stacking environment, comprising:
creating a prepended frame descriptor to a packet; and
placing a SecTag in the prepended frame descriptor.

2. The method of claim 1, further comprising placing SecTag control information in the prepended frame descriptor.

3. The method of claim 2, further comprising placing the SecTag in a next six bytes following the SecTag.

4. A method of enabling Pause in a frontside stacking environment, comprising:
identifying a size of a packet; and
if the size of a packet is less than or equal to 64 bytes, examining the packet for a Pause frame format.

5. A method of identifying OAM in a frontside stacking environment, comprising:
identifying a size of a packet; and
if the size of a packet is less than or equal to 64 bytes, examining the packet for an OAM frame format.

6. A method of enabling SPAN in a frontside stacking network, comprising:
receiving an incoming spanSessionMap from a frontside stack frame descriptor;
generating a second spanSessionMap that encompasses a frontside stack port to a span session;
logically OR'ing the incoming spanSessionMap with the second spanSessionMap to form a resultant spanSessionMap; and
placing the resultant spanSessionMap in the frontside stack frame descriptor.

7. A method of operating a first switch and a second switch as respective active and standby switches connected by dual active detection (“DAD”) links, comprising:
when the second switch becomes active, checking if a port on the second switch associated with the DAD Link is up;
when the DAD link is up, triggering a reload message over the DAD link from the second switch to the first switch and setting the second switch as the active switch;
when the first switch receives the reload message over the DAD link, reloading the first switch; and
when the first switch comes up as a standby switch and when a stack is not formed, sending from the first switch to the second switch a reload message over the DAD link.

8. The method of claim 7, further comprising when the second switch becomes the active switch, storing the prior state of the second switch in a first variable.

9. The method of claim 7, further comprising when the first switch becomes the standby switch, storing the prior state of the first switch in a second variable.

10. The method of claim 7, further comprising when the second switch becomes the active switch and the first switch becomes the standby switch:
reloading the second switch.

11. The method of claim 10, further comprising when a stack is not formed on the second switch, shutting down a network interface port on the second switch.

12. The method of claim 10, further comprising when a stack is not formed on the second switch, shutting down all network interface ports on the second switch.

13. A method of sending hello messages from a first switch to a second switch over a dual active detection (“DAD”) link, comprising:
sending an Ethernet OAM based hello over the DAD link from the first switch to the second switch.

14. The method of claim 13, further comprising sending an Ethernet OAM based hello over the DAD link from the second switch to the first switch.

15. The method of claim 14, further comprising generating an interrupt at the first switch if a hello message is not received from the second switch.

16. The method of claim 14, further comprising polling from a CPU at the first switch to an ASIC at the first switch to determine if a hello message is not received from the second switch.

17. The method of claim 14, wherein when an interrupt is received at the first switch, setting the first switch from a standby mode to an active mode.

18. The method of claim 14, wherein when an interrupt is received at the first switch, where the first switch is the active switch, generating a notification that the second switch is not online.

19. The method of claim 14, wherein hello messages are sent in a time of less than 10 ms.

20. The method of claim 14, wherein hello messages are sent in a time of less than 5 ms.
